(19) United States
(12) Patent Application Publication
(10) Pub. No.: US 2014/0010941 A1
(43) Pub. Date: Jan. 9, 2014

(54) Switchback Mack's Genuine American Hot Sauce

(71) Applicant: Clifford Henry Hyatt, Windsor, CT (US)

(72) Inventor: Clifford Henry Hyatt, Windsor, CT (US)

(21) Appl. No.: 13/542,333

(22) Filed: Jul. 5, 2012

(51) Int. Cl. A23L 1/39

(52) U.S. Cl. CPC A23L 1/39
USPC 426/589; 426/518

(57) ABSTRACT

The object of the invention is a spicy, all natural pepper sauce, which incorporates three diverse culinary traditions into a unique American flavor experience.

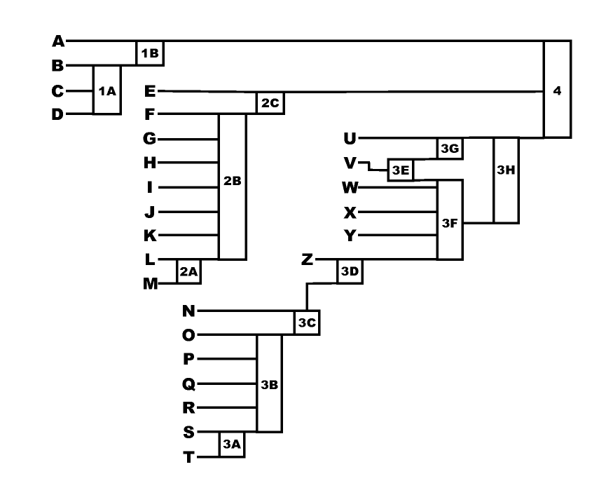

### DESCRIPTION OF THE DRAWING

The drawing is a rendering of the interrelated processes that comprise Switchback Mack's Genuine American Hot Sauce.

### FIELD OF THE INVENTION

The present invention relates generally to a food preparation method and specifically to a spicy, all natural pepper sauce.

### SUMMARY OF THE INVENTION

In accordance with the present invention, a food product primarily comprising various peppers and spices provides a spicy sauce. More particularly this spicy pepper sauce is a composition comprising an admixture of:
(a) chili pepper sauce
(b) southeastern pepper sauce
(c) scotch bonnet pepper sauce.

This invention also relates to a method of preparing this protected composition which comprises
(a) heating Operation 2A, a liquid admixture to 212 degrees F. and Operation 4 to 160 degrees F.
(b) cooling Operation 2A to 180 degrees F.
(c) combining Operations 1A, 1B, 2A, 2B, 2C, 3B, 3C, 3D, 3F, 3G, 3H, 4
(d) dividing Operation 3E into 3Ea and 3Eb
(e) pureeing Operations 3C, 3F, 3G and
(f) cutting Operation 3A.

### DETAILED DESCRIPTION OF THE PREFERRED EMBODIMENTS

An example of a typical composition of the ingredients to prepare one gallon of spicy pepper sauce uses the following volume proportions. Of the 128 fluid ounces of volume, 28%, or approximately 36 fluid ounces, are displaced by solid ingredients. The solid ingredient volume weighs approximately 79.2 ounces. The detailed description of the solid ingredient volume follows:
Ancho Chili Powder (B) 1.77% of solid volume
Chipolte Chile Powder (C) 1.97% of solid volume
de Arbol Chili Powder (D) 1.87% of solid volume
Ground Cayenne Pepper (F) 4.13% of solid volume
Ground White Pepper (G) 2.56% of solid volume
Salt (H) 2.17% of solid volume
Ground Allspice (I) 0.98% of solid volume
Ground Cinnamon (J) 0.98% of solid volume
Mustard Powder (K) 0.98% of solid volume
Raw Sugar (L) 8.07% of solid volume
Ground Allspice (O) 0.79% of solid volume
Garlic (Q) 15.16% of solid volume
Raw Sugar (R) 5.71% of solid volume
Yellow Onion (S) 7.48% of solid volume
Scotch Bonnet Peppers (T) 5.91% of solid volume
Garlic (U) 1.97% of solid volume
Ginger Shavings (Y) 34.65% of solid volume
Five Spice Powder (Z) 3.15% of solid volume

The remaining 72%, or approximately 94 fluid ounces of volume, are the wet ingredients.

The detailed description of the wet ingredients follows:
Rice Vinegar (A) 17.16 fl oz of total volume
Cider Vinegar (E) 17.16 fl oz of total volume
Water (M) 22 fl oz of total volume
Cider Vinegar (N) 2.34 oz of total volume
Lime Juice (P) 4.68 fl oz of total volume
Maple Syrup (V) 21.84 fl oz of total volume
Fish Sauce (W) 3.15 fl oz of total volume
Sesame Oil (X) 0.5 fl oz of total volume

The Chili Pepper Sauce Process is composed of two operations. In Operation 1A, ingredients B (Ancho Chili Powder), C (Chipolte Chili Powder) & D (de Arbol Chili Powder) are combined until uniform consistency is achieved. In Operation 1B, ingredient A (Rice Vinegar) is combined with the output of Operation 1A until uniform consistency is achieved. The resulting Chili Pepper Sauce admixture is staged for consolidation.

The Southeastern Pepper Sauce Process is composed of three operations. In Operation 2A, combine ingredients L (Raw Sugar) and M (Water) until uniform consistency is achieved. Heat the resulting admixture to 212 degrees F., creating a simple syrup. Reduce heat and allow admixture to cool to 180 degrees F. Initiate Operation 2B by combining ingredients F (Cayenne Pepper), G (White Pepper), H (Salt), I (Allspice), J (Cinnamon), K (Mustard) until uniform consistency is achieved. Combine resulting composition with the output of Operation 2A until uniform consistency is achieved. Remove heat from admixture. In Operation 2C, combine ingredient E (Cider Vinegar) with output of Operation 2B until uniform consistency is achieved. The resulting Southeastern Pepper Sauce admixture is staged for consolidation.

The Scotch Bonnet Pepper Sauce Process is composed of eight operations. In Operation 3A, peel and chop ingredient S (Yellow Onion).Trim stems and waste from ingredient T (Scotch Bonnet Peppers). Initiate Operation 3B by combining ingredients O (Allspice), P (Lime Juice), Q (Garlic), R (Sugar) until uniform consistency is achieved. Combine resulting composition with the output of Operation 3A until uniform consistency is achieved. In Operation 3C, combine ingredient N (Cider Vinegar) and the output of Operation 3B until uniform consistency is achieved. Puree the resulting admixture. In Operation 3D, combine Ingredient Z (Five Spice Powder) with the output of Operation 3C until uniform consistency is achieved. In Operation 3E, divide ingredient V (Maple Syrup) into two portions, ingredients 3Ea (45% of Maple Syrup volume) and 3Eb (55% of Maple Syrup volume). In Operation 3F, combine W (Fish Sauce), X (Sesame Oil), Y (Ginger Shavings), 3Ea (Maple Syrup) with the output of Operations 3D until uniform consistency is achieved. Puree the resulting admixture. In Operation 3G, combine ingredients U (Garlic) 3Eb (Maple Syrup) until uniform consistency is achieved. Puree the resulting admixture. In Operation 3H, combine the outputs of Operations 3F and 3G until uniform consistency is achieved. The resulting Scotch Bonnet Pepper Sauce admixture is staged for consolidation

The Consolidation Process is composed of one operation. Initiate Operation 4, by combining the staged outputs of Operations 1B, 2C and 3H until uniform consistency is achieved. Heat the resulting admixture to 160 degrees F. for twelve hours.

It will be appreciated that the above example is representative of the invention but various modifications may be made in keeping with the spirit and scope of the invention as defined in the following claims. For example, other peppers and/or onions such as habanero peppers and/or Visalia onions may be used in place of scotch bonnet peppers and/or yellow onions. The amounts of the ingredients may be varied in order to make lesser or larger batches of the sauce, as long as the relative proportions are maintained.

One skilled in the art would readily appreciate that the present invention is well adapted to obtain the ends and advantages mentioned, as well as those inherent therein. The methods, variances , and compositions described herein as presently representative of preferred embodiments are exemplary and not intended as limitations on the scope of the invention. Changes therein and other uses will occur to those skilled in the art, which are encompassed within the spirit of the invention, are defined by the scope of the claims. It will be readily apparent to one skilled in the art that varying substitutions and modifications may be made to the invention disclosed herein without departing from the scope and spirit of the invention. For example, variations can be made to the precise proportions of ingredients. Thus such additional embodiments are within the scope of the present invention and the following claims.

1. A pepper sauce composition comprising an admixture of:
(a) Chili pepper sauce; and
(b) Southeastern pepper sauce; and
(c) Scotch Bonnet pepper sauce.

2. A pepper sauce according to claim 1 wherein the admixture contains Ground Allspice (I, O).

3. A pepper sauce according to claim 1 wherein the admixture contains Ancho Chili Powder (B).

4. A pepper sauce according to claim 1 wherein the admixture contains Ground Cayenne Pepper (F).

5. A pepper sauce according to claim 1 wherein the admixture contains Chipolte Chili Powder (C).

6. A pepper sauce according to claim 1 wherein the admixture contains Cider Vinegar (E, N).

7. A pepper sauce according to claim 1 wherein the admixture contains Ground Cinnamon (J).

8. A pepper sauce according to claim 1 wherein the admixture contains de Arbol Chili Powder (D).

9. A pepper sauce according to claim 1 wherein the admixture contains Fish Sauce (W).

10. A pepper sauce according to claim 1 wherein the admixture contains Five Spice Powder (Z).

11. A pepper sauce according to claim 1 wherein the admixture contains Garlic (Q, U).

12. A pepper sauce according to claim 1 wherein the admixture contains Ginger Shavings (Y).

13. A pepper sauce according to claim 1 wherein the admixture contains Scotch Bonnet Peppers (T).

14. A pepper sauce according to claim 1 wherein the admixture contains Lime Juice (P).

15. A pepper sauce according to claim 1 wherein the admixture contains Maple Syrup (V).

16. A pepper sauce according to claim 1 wherein the admixture contains Mustard Powder (K).

17. A pepper sauce according to claim 1 wherein the admixture contains Yellow Onion (S).

18. A pepper sauce according to claim 1 wherein the admixture contains Rice Vinegar (A).

19. A pepper sauce according to claim 1 wherein the admixture contains Salt (H).

20. A pepper sauce according to claim 1 wherein the admixture contains Sesame Oil (X).

21. A pepper sauce according to claim 1 wherein the admixture contains Raw Sugar (L, R).

22. A pepper sauce according to claim 1 wherein the admixture contains Water (M).

23. A pepper sauce according to claim 1 wherein the admixture contains Ground White Pepper (G).

24. A method of preparing a pepper sauce composition which comprises:
(a) heating, Operation 2A, a liquid admixture, to 215 degrees F., Operation 4, a liquid admixture, to 160 degrees F.; and
(b) cooling, Operation 2A, to 180 degrees F.; and
(c) combining, Operations 1A, 1B, 2A, 2B, 2C, 3B, 3C, 3D, 3F, 3G, 3H, 4; and
(d) dividing, Operation 3E, into 3Ea-3Eb; and
(e) pureeing, Operations 3C, 3F, 3G; and
(f) cutting, Operation 3A.

25. A method according to claim 24 wherein uniform consistency is achieved combining three inputs (B, C, D).

26. A method according to claim 24 wherein uniform consistency is achieved combining two inputs (1A, A).

27. A method according to claim 24 wherein uniform consistency is achieved combining two inputs (L, M).

28. A method according to claim 24 wherein liquid admixture 2A is heated to 212 degrees F.

29. A method according to claim 24 wherein liquid admixture 2A is cooled to 180 degrees F.

30. A method according to claim 24 wherein uniform consistency is achieved combining seven inputs (2A, F, G, H, I, J, K).

31. A method according to claim 24 wherein uniform consistency is achieved combining two inputs. (2B, E)

32. A method according to claim 24 wherein uniform consistency is achieved cutting two inputs. (S, T).

33. A method according to claim 24 wherein uniform consistency is achieved combining five inputs. (3A, O, P, Q, R).

34. A method according to claim 24 wherein uniform consistency is achieved combining two inputs. (3B, N).

35. A method according to claim 24 wherein uniform consistency is achieved pureeing one input. (3C).

36. A method according to claim 24 wherein uniform consistency is achieved combining two inputs. (3C, Z).

37. A method according to claim 24 wherein one input is divided into two outputs (3E/3Ea-3Eb).

38. A method according to claim 24 wherein uniform consistency is achieved combining five inputs (3D, 3Ea, W, X, Y).

39. A method according to claim 24 wherein uniform consistency is achieved pureeing one input (3F).

40. A method according to claim 24 wherein uniform consistency is achieved combining two inputs (3Eb, U).

41. A method according to claim 24 wherein uniform consistency is achieved pureeing one input. (3G).

42. A method according to claim 24 wherein uniform consistency is achieved combining two inputs. (3F, 3G).

43. A method according to claim 24 wherein uniform consistency is achieved combining three inputs. (1B, 2C, 3H).

44. A method according to claim 24 wherein liquid admixture 4 is heated to 160 degrees F.
